(19) United States
(12) Patent Application Publication
(10) Pub. No.: US 2011/0286243 A1
(43) Pub. Date: Nov. 24, 2011

(54) ISOLATED FEEDBACK SYSTEM FOR POWER CONVERTERS

(75) Inventors: Wei-Chan HSU, Chupei City (TW); Li-Te Wu, Chupei City (TW)

(73) Assignee: NeoEnergy Microelectronics, Inc.

(21) Appl. No.: 13/111,931

(22) Filed: May 19, 2011

Related U.S. Application Data
(60) Provisional application No. 61/347,397, filed on May 22, 2010.

(51) Int. Cl. H02M 7/00

(52) U.S. Cl. 363/13

(57) ABSTRACT

An isolated feedback system for power converters includes an error amplifier for receiving an input voltage to output an error signal; a modulator circuit to modulate the error signal with a carrier signal; an acoustic transformer unit, one end of the acoustic transformer connected to the modulator circuit, where a frequency of the carrier signal is away from resonant frequencies of the acoustic transformer; and a demodulation circuit connected to the other end of the acoustic transformer and receiving the modulated signal.

### CROSS REFERENCE TO RELATED APPLICATIONS

This application claims priority of U.S. Provisional Application No. 61/347,397 filed on May 22, 2010 under 35 U.S.C. §119(e), the entire contents of which are hereby incorporated by reference.

### BACKGROUND OF THE INVENTION

1. Field of the Invention

The present invention relates generally to a feedback system for power converters, and more particularly to an isolated feedback system using off-resonant frequencies of acoustic transformer for power converters.

2. Description of The Prior Art

1. Introduction to Power Converter

A power converter such as an AC/DC adapter converts input AC power into a DC power source for different applications. AC/DC adapters are used in many consumer electronics systems, computers, and network equipment. A flyback converter is a very popular conversion architecture.

A conventional current mode flyback converter is shown in FIG. 1. In the conventional flyback system, output regulation is provided through the optocoupler OPTO. In one popular implementation, the output voltage Vout is divided into a voltage Vdiv through a resistor network. The voltage Vdiv controls the shunt regulator TL431 which generates a current proportional to the difference of the voltage Vdiv and an internal regulated voltage in the shunt regulator TL431, typically at 2.5V. The current generated will be converted into a feedback voltage FB through the optocoupler OPTO. The PWM controller 10A uses the FB signal to control the on time of the switch Q such that proper voltage regulation is achieved. The optocoupler OPTO serves as an isolation signal transmitter. It provides isolation while transmitting signals across the isolation layer between the primary side and the secondary side. The isolation is required to avoid ground loop currents as the ground levels on the primary side and the secondary sides may be different. This is also known as galvanic isolation.

In FIG. 1, the regulation of the AC/DC converter depends on a feedback system consists of the shunt regulator TL431 and the optocoupler OPTO. The feedback system is extracted from FIG. 1 and is shown in FIG. 2. In the feedback system, the popular shunt regular TL431 acts as a transconductance amplifier. The shunt regular TL431 generates the current IS when the voltage Vin in the secondary side is above a built-in internal reference Vref, typically at 2.5V. The transconductance provided by the shunt regular TL431 is in the range of a few mA/V to a few AN, depending on the value of Vin and the biased current IS. The biased current IS is transferred to the primary side as the current IP. The ratio of currents IP and IS is referred as Current Transfer Ration (CTR). Depending on the type of optocoupler, typical CTR ranges from 0.5 to 5. The current IP will pull the feedback voltage FB low. This condition exists when the load is light or when the voltage Vin is greater than Vref.

In the case that Vin is smaller than Vref, or in the cases of a normal or heavy load condition, IS and IP are close to zero. The feedback voltage FB will be pulled up by a resistor Ru. In FIG. 2, Cc and Rc are a compensation capacitor and resistor. They are required to make the overall feedback system stable.

2. The Drawbacks of the Feedback System Based on an Optocoupler

The feedback system shown on FIG. 2 is very popular today as it is simple and inexpensive. There are, however, a few well-known drawbacks for this feedback system:

1). The optocoupler OPTO and the shunt regulator TL431 consumes large amount of current. Typically each of them requires about 1 mA of current consumption to operate properly. For a 20 Volts output, the power consumption will be in the range of 20 mW to 40 mW.

2). The optocoupler OPTO performance degrades as it ages. CTR decreases with time especially at high temperatures.

3). The transconductance of the optocoupler OPTO (or the shunt regulator TL431) varies greatly depending on the input voltage level.

3. Other Types of Transformers

Instead of using optocouplers, other types of transformer can be used to transmit the signals from the secondary side to the primary side. Two well-known transformers are inductive transformers and capacitive transformers:

3.1. Inductive Coupling

Inductive coupling uses a changing magnetic field between two coils to communicate across an isolation barrier. The most common example is the transformer where the strength of the magnetic field depends on the coil structure (number of turns/unit length) of the primary and secondary windings, the permittivity of the magnetic core, and the current magnitude. An example of inductive coupling is shown in FIG. 3A, where a signal sender 11A sends signal to a signal receiver 12A through the two coils.

One variation of the inductive coupling is to replace the secondary coil with a resistor network, the resistors are being made of a GMR (giant magneto-resistor) material so that when a magnetic field is applied, the resistance changes. The circuitry senses the change in resistance, and conditions it for output. FIG. 3B shows an example of an inductive coupler with GMR, where a signal sender 11A sends signal to a signal receiver 12A through a coil and a resistor network.

3.2. Capacitive Coupling

Capacitive coupling uses a changing electric field to transmit information across the isolation barrier. The material between the capacitor plates is a dielectric insulator and forms the isolation barrier. The plate size, distance between the plates, and the dielectric material determine the electrical properties. A simplified diagram of capacitive coupling is shown in FIG. 3C, where a signal sender 11A sends signal to a signal receiver 12A through a dielectric insulator 13A.

3.3 Digital Isolators

Inductive and capacitive type transformers have different properties and advantages in terms of: signal bandwidth, power consumption, immunity of acoustic noise, and the immunity of electrical or magnetic field. The pros and cons are summarized in TI's Application Report [Texas Instruments Application Report SLLA198—January 2006: The ISO72x Family of High-Speed Digital Transformers.]. One common property for these types of transformers is that a DC signal cannot be transmitted through the isolation barrier. In addition, to reduce the effect of external noise, it is preferable not to transmit the low frequency signal directly, but to digitize the signal into digital bits. The data are modulated at a higher frequency, transmitted through the isolation layer, and then demodulated and recovered at the receiving end. There are many digital isolators on the market. Examples are TI72x family, ADI's ADUM1100, Silicon Labs' Si8400, etc. All of them use some form of modulation and demodulation to transmit data.

The block diagram of a feedback system using digital isolators to transmit low frequency analog signals is shown in FIG. 3D, where an input signal Vin is sent through an analog-to-digital convertor (ADC) 14A, a modulator 15A, an isolator 16A, a demodulator 17A and a digital-to-analog converter (DAC) 18A, and an output signal Vout is output from the DAC 18A. In principle, the feedback system shown in FIG. 2 can be implemented using this method.

While digital isolators provide a good solution to sending data across the isolation layer, it suffers a few disadvantages when used as part of the feedback system:

1). The power consumption is high because an ADC and DAC are required.

2). The latency from input to output is higher because of the extra delays required by ADC and DAC.

3). The cost is higher because ADCs and DACs are added to the system.

For power converter feedback system, it is preferable to modulate and transmit the low frequency analog signals directly as illustrated in FIG. 3E, where an input signal Vin is sent through a modulator 15A, an isolator 16A and a demodulator 17A, and an output signal Vout is output from the demodulator 17A.

Brian T. Irving and Milan M. Jovanovi suggest using a magnetic transformer with a modified AM modulation to replace the optocoupler (See, Analysis and Design Optimization of Magnetic-Feedback Control Using Amplitude Modulation, IEEE TRANSACTIONS ON POWER ELECTRONICS, VOL. 24, NO. 2, FEBRUARY 2009). Both modulation and demodulation are done by a switch on the primary side. The method relies on the shunt regulator TL431 to amplify the error signal and the transmission of the error signal is similar to those customary in AC/DC converters using auxiliary windings.

4. Acoustic Transformer

While inductive and capacitive type transformers are used extensively, they have a few disadvantages when used as the transformer for a power converter. Since both transformers are relying on electromagnetic waves to transmit the signals, the signals needs to be modulated or encoded at carrier frequencies high enough that the equivalent impedance is low. Typically, the carrier frequency is from tens of megahertz to a gigahertz range. Hence, it is more suitable for high bandwidth applications such as a high data rate transceiver. For a low frequency application, it is not an optimum solution.

For low frequency applications such as the power converter feedback system, ideal solutions are using transformers which only need modest carrier frequencies to transmit the signal across the isolation barrier. For example, if the signal bandwidth is 10 kHz, an ideal modulated frequency should be around 100 k to 1 MHz. Ultrasonic acoustic transforms are ideal for this purpose as they are designed to operate from a few kHz to a few MHz.

Acoustic transformers consist of a transmitting end and a receiving end. Using an acoustic wave as a medium, the electrical energy is transmitted from the transmitting end to the receiving end. A simplified functional diagram for an acoustic transformer which illustrates this operating principle is shown in FIG. 4A. The acoustic transformer consists of three major components: (1) A transducer 19A to convert the electrical energy into acoustic waves, (2) An isolation layer 20A to provide the necessary isolation and serve as the medium for the acoustic waves, and (3) A receiver 21A (or an acoustic to electrical transducer) to converter the acoustic energy into electrical energy.

There are many different ways to implement the acoustic transformer. The most straightforward method is shown in FIG. 4B where acoustic waves are generated by an ultrasonic transducer 22A, the acoustic waves propagate through the air 23A and are picked up by an ultrasonic receiver 24A and converted into an electrical signal Vout. The air is a non-conducting material and provides the necessary isolation. This method is most straightforward but not practical for most systems due to the large size of the transducers and the distance between them.

A compact acoustic transformer is a piezoelectric transformer which is shown in FIG. 4C. The piezoelectric transformer is constructed with layers of piezoelectric material 25A. When a voltage Vin is applied to the primary side, it causes mechanical expansion or compression in that direction. This displacement on the primary side is transferred as a force in the longitudinal or length direction and induces a voltage output Vout. Piezoelectric material itself is not electrically conductive, hence it provides good isolation between the input and output ends.

Another example of piezoelectric material is illustrated in US application US 2009/0309460. The structure consists of a single piece of piezoelectric material 26A with two electrodes 27A and 28A on two terminals separated with some predetermined distance. When a voltage is applied to an electrode at one end, the material will be deformed and the deformation will be propagated to the other side of the material in the form of an acoustic wave. The deformation will induce a voltage change on the other end. The transformer is shown in FIG. 4D.

There are many different forms of acoustic transformers. For example, FIG. 2 of U.S. Pat. No. 7,514,844 shows an acoustic transformer made of stacked file bulk acoustic resonators (FBAR). Alternative embodiments of acoustic transformer are disclosed in U.S. Pat. Nos. 6,95,4121, 6,946,928, 6,927,651, etc. Major advantages of acoustic transformers are:

1. It can be fabricated with modern technology and the size is very small. Hence it is possible to integrate the whole feedback system into one compact package.

2. The power required to stimulate and receive acoustic signals is very small. In general, it is at least an order of magnitude smaller than what are required for other types of transformers.

5. Acoustic Transformer as Transformer in Feedback System

The possibility of using a piezoelectric transformer (PT) in a power converter feedback system has been studied by S. Lineykin and S. Ben-Yaakov (See, “Feedback isolation by piezoelectric transformers: comparison of amplitude to frequency modulation,” Power Electronics Specialists Conference PESC'04, pp. 1834-1840, June 2004, Aachen, Germany.) It has been found that it is possible to transmit signals through PT with both AM and FM modulation schemes as shown in FIG. 5A, where an input signal Vin is differential-amplified by an amplifier 40A and then processed by a modulator 41A, a PT 42A and a rectifier 43A.

Depending on the shape, thickness, and the material used, in a typical PT and other acoustic transformer, the frequency response typically consists of different peaks or resonant frequencies. An example of a frequency response plot of a PT is shown in FIG. 5B, where DM and CM are differential voltage gain and common-mode voltage gains.

FIG. 5C shows the definitions of Vin and Vout. The differential gain DM is defined as the voltage gain Vout/Vin when GND1 and GND2 are held steady. C11, C12, C21 and C22 are the parasitic coupling capacitances between different electrical terminals. These parasitic elements will degrade the performance of the signal transfer. For example, when the voltage at GND1 varies with respect to GND2 while Vin remains the same, Vout will be affected via C22 and C21. This voltage gain is referred as CM, or common-mode gain.

For piezoelectric transformers and many other acoustic transformers, there exist one or more resonant frequencies which depend on the design, material used, size and aspect ratios. In FIG. 5B, there are resonant frequencies at 210 k, 230 k and 350 k. The common mode voltage gain is also shown in FIG. 5B. The ratio of DM/CM, or the common mode rejection ratio CMRR, is the best at 230 k and 210 k. For PT, S. Lineykin and S. Ben-Yaakov conclude that it is desirable to choose the carrier frequency near a resonant frequency of PT as the signal strength will be larger and easier to detect. Additionally, in the some cases, CMRR is high when operated at this region. The resonant characteristic resembles a band pass filter, in that noises in other frequencies are rejected (for example, see U.S. Pat. No. 7,514,844). U.S. Pat. No. 7,514,844 proposes the use of PT for discrete data transfers and also suggests choosing the carrier frequencies near the resonant frequency (See claims 8, 12, 25, 29 thereof).

While there are advantages of choosing the carrier frequency near a resonant frequency, there are a few major drawbacks:

(1) The resonant frequency may vary due to variations in material property, variations when constructing of the device, temperature and bias condition. The variation makes it difficult to manufacture large quantity of devices with consistent performance.

(2) While the voltage gain, or the quality factor, is higher at resonance, it varies with material used, variations when constructing of the device, temperature and bias condition.

(3) The frequency response (both magnitude and phase) near the resonant frequency changes drastically as the frequency changes. For example, in FIG. 5B, the gain changes with a factor of 10 from 200 k to 210 k. The large variation means the modulation can only be applied for very narrow band signals as suggested by S. Lineykin and S. Ben-Yaakov.

Therefore, it is desirable to provide an acoustic transformer to overcome the above disadvantages.

### SUMMARY OF THE INVENTION

It is an object of the present invention to provide an isolated feedback system for power converters, which uses the region off the resonant frequencies of the acoustic transformer to eliminate the impact of material variation.

Accordingly, the present invention provides an isolated feedback system for power converters, which comprises an error amplifier for receiving an input voltage to output an error signal; a modulator circuit to modulate the error signal with a carrier signal; an acoustic transformer unit, one end of the acoustic transformer connected to the modulator circuit, where a frequency of the carrier signal is away from resonant frequencies of the acoustic transformer; and a demodulation circuit connected to the other end of the acoustic transformer and receiving the modulated signal.

According to one aspect of the invention, the error amplifier is a fully-differential error amplifier and outputs two differential signals, and the two differential signals are modulated by the modulator circuit to two modulated signals.

According to another aspect of the invention, the acoustic transformer unit comprises a first acoustic transformer and a second acoustic transformer for receiving the two modulated signals respectively.

According to still another aspect of the invention, the feedback system further comprises a subtractor connected to the output of the demodulation circuit, wherein the subtractor subtracts two demodulated signals output from the demodulation circuit. Alternatively, the feedback system further comprises a subtractor connected between the acoustic transformer unit and the demodulation circuit to subtract the output signals of the first acoustic transformer and the second acoustic transformer.

According to still another aspect of the invention, the present invention provides a method for providing isolated feedback for power converters and the method comprises: (a) receiving an input voltage and a reference voltage to output at least one error signal; (b) modulating the error signal to generate at least one modulated signal; (c) sending the modulated signal through the acoustic transformer unit; and (d) demodulating at least one output signal of the acoustic transformer unit.

### BRIEF DESCRIPTION OF THE DRAWINGS

The invention may be best understood by reference to the following detailed description of the invention, which describes certain exemplary embodiments of the invention, taken in conjunction with the accompanying drawings in which:

FIG. 1 shows a conventional current mode flyback converter.

FIG. 2 shows the feedback system used for the current mode flyback converter in FIG. 1.

FIG. 3A is a schematic drawing showing inductive coupling.

FIG. 3B shows an inductive coupler with GMR.

FIG. 3C shows a simplified diagram of capacitive coupling.

FIG. 3D shows a block diagram of a feedback system using digital isolators to transmit low frequency analog signals.

FIG. 3E shows a block diagram of a feedback system directly modulating and transmitting the low frequency analog signals.

FIG. 4A is a simplified functional diagram for an acoustic transformer to illustrate the operating principle.

FIG. 4B demonstrates a most straightforward method for implementing an acoustic transformer.

FIG. 4C shows a compact acoustic transformer realized by a piezoelectric transformer.

FIG. 4D shows an acoustic transformer using piezoelectric material.

FIG. 5A is a block diagram of a piezoelectric transformer (PT) isolator with FM or AM excitation.

FIG. 5B shows the frequency response of differential mode (DM) and common mode (CM) transfer ratios of piezoelectric transformer.

FIG. 5C demonstrates the definition of voltages used in FIG. 5B.

FIG. 6A illustrates the frequency response of an input filter used for the present invention.

FIG. 6B shows the frequency response of the acoustic transformer for implementing the isolated feedback system of the present invention.

FIG. 7A shows the block diagram of the proposed feedback system according to a preferred embodiment of the present invention.

FIG. 7B shows the block diagram of the proposed feedback system according to another preferred embodiment of the present invention.

FIG. 7C shows the block diagram of the proposed feedback system according to still another preferred embodiment of the present invention.

FIG. 8 shows an example of a peak detection circuit.

FIGS. 9A-9F shows waveforms of signals transmitted through the system shown in FIG. 7A.

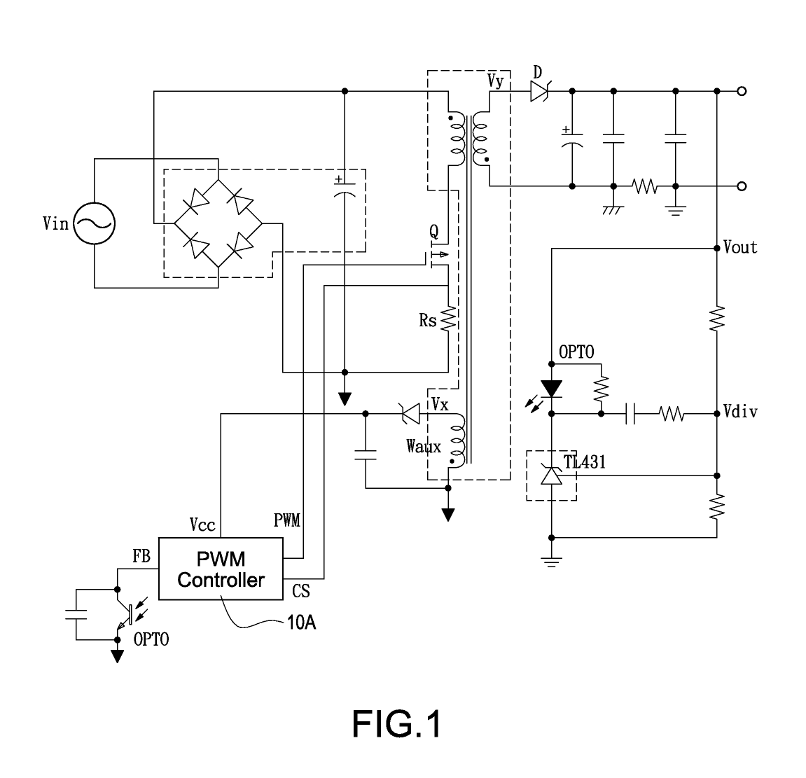

### DETAILED DESCRIPTION OF THE PRESENT INVENTION

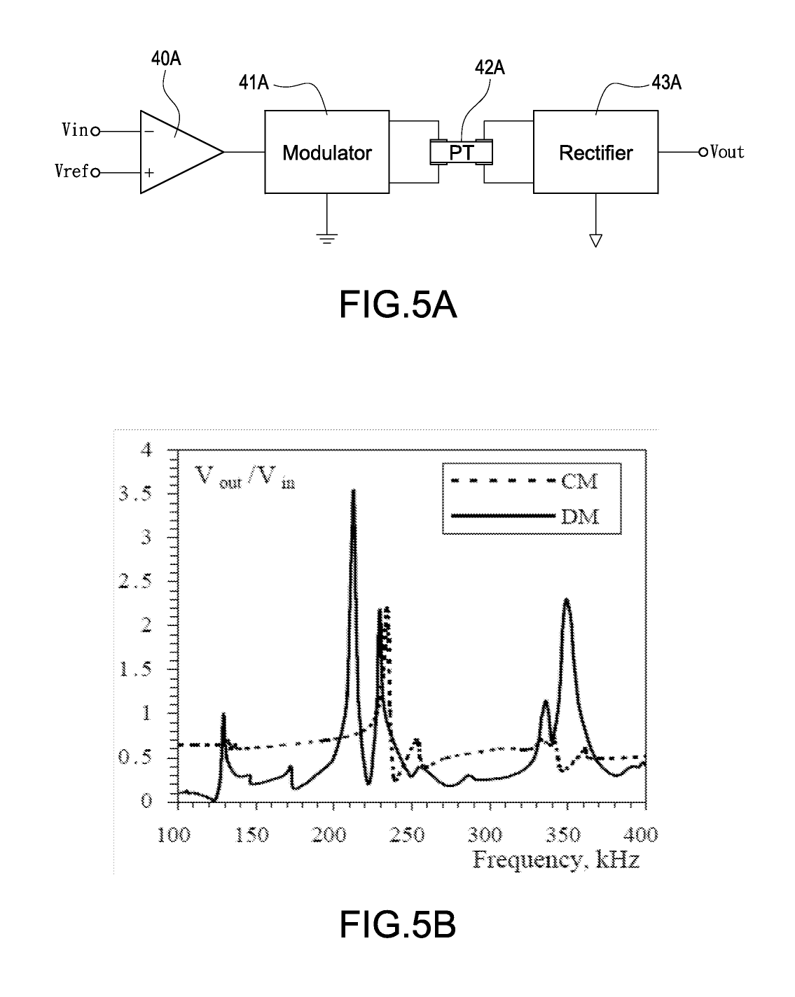

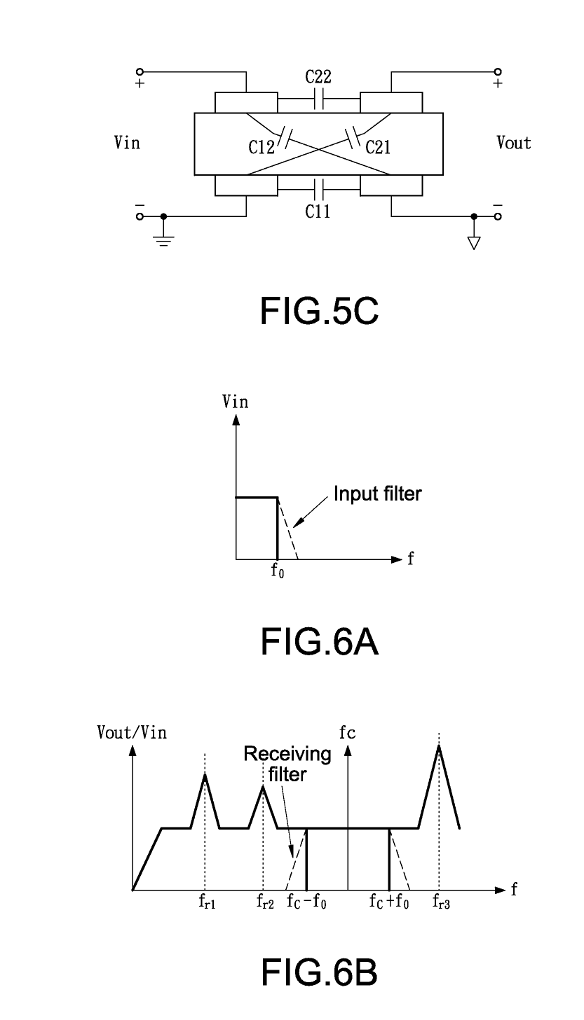

The present invention proposes an isolated feedback system for power converters, which operates off the resonant frequencies to take advantage of the flat frequency response. For example, the frequency between 250 k and 350 k in FIG. 5B has relatively constant DM. It is possible to design a PT or other type of acoustic transformer which has an even flatter frequency response. However, the issues with acoustic transformer operating in the flat region are:

1. The CMRR may be poor. As shown in FIG. 5B, the CMRR=CM/DM is from −3 to −10 dB. It means the transformer is susceptible to ground noise.

2. While it is desirable to have a flat frequency response which allows the transmission of signals with low distortion, the band pass nature of the transformer is lost in that unwanted noises at other frequencies are easier to be transmitted through the transformer.

According to the present invention, the issues mentioned in the above sections are handled with the structure of the transformer and circuit techniques as explained below:

1. CMRR issue. This can be resolved using a differential structure. It is well known in analog circuit design that a differential structure can easily reject 60 dB to 80 dB of the common mode signal. The acoustic transformer fabricated on the same substrate using modern MEMS technology should achieve the same level of performance. The concern of CMRR mentioned by S. Lineykin and S. Ben-Yaakov can be resolved.

2. Out of signal band noise issue. Since the frequencies of interest are now in the flat region, there is a concern that out of band noise can also be transmitted and mixed into the modulated signal which will affect the system performance. It is especially a concern that the noises near the resonant frequencies are transmitted as the gain is high. This problem can be solved by adding filters in the system. On the transmit side, a low pass filter can be added at the input which will limit the signal bandwidth such that the modulated signal will not enter the resonant region. On the receive side, a band pass filter can be added before the demodulation circuit to filter out unwanted signals.

To explain the operation of the isolated feedback system of the present invention, the operation of AM modulation is first explained below.

Assuming the input signal is a monotone signal with a frequency at fm=2 πωm, where 0<fm<f0, and f0 is the required bandwidth for the input signal.

Vin(t)=Vin×cos (ωₘt)

The carrier signal is expressed as

Vc(t)=Vc×cos (ω_{c}t)

Where ω_{c} is the angular frequency of the carrier, fc=2 πωm. For AM modulation, the input signal is added with a constant DC common mode voltage, Vcm, to assure its amplitude is positive then multiplied by the carrier signal before transmission. The modulated signal is

$${V}_{t} = ( Vcm + {V}_{m} cos ( {ω}_{m} t ) ) \times {V}_{c} cos ( {ω}_{c} t )$$

$${V}_{t} = {VcmV}_{c} cos ( {ω}_{m} t ) + \frac{{VcmV}_{c}}{2} cos ( ( {ω}_{m} + {ω}_{c} ) t ) + \frac{{VcmV}_{c}}{2} cos ( ( {ω}_{m} - {ω}_{c} ) t )$$

Since fm=2 πωm is between 0 and f0, the modulated signal will have signal band between (fc−fo) and (fc+f0).

FIG. 6A illustrates the frequency response of the input low pass filter used for an embodiment of the present invention, where the signal of interest is confined between DC and f0. When system performance is demanding and unwanted signals are not allowed to be coupled into the system and amplified, an input filter, a receiving filter or both can be optionally added into the system. FIG. 6B shows the frequency response of the acoustic transformer for implementing the isolated feedback system of the present invention. As shown in FIG. 6B, fr1, fr2 and fr3 indicate resonant frequencies of the acoustic transformer. In this example, the carrier frequency fc is chosen to be between fr2 and fr3 if (fr3−fr2) is greater than the required bandwidth 2f0. The modulated signal will safely lie in the flat region between fr2 and fr3 where the frequency response is relatively flat.

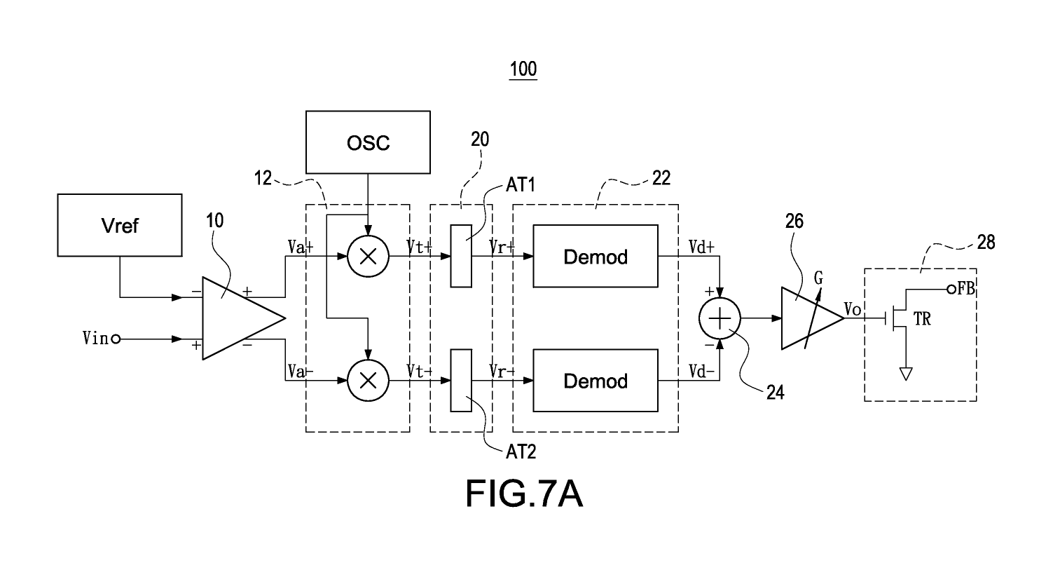

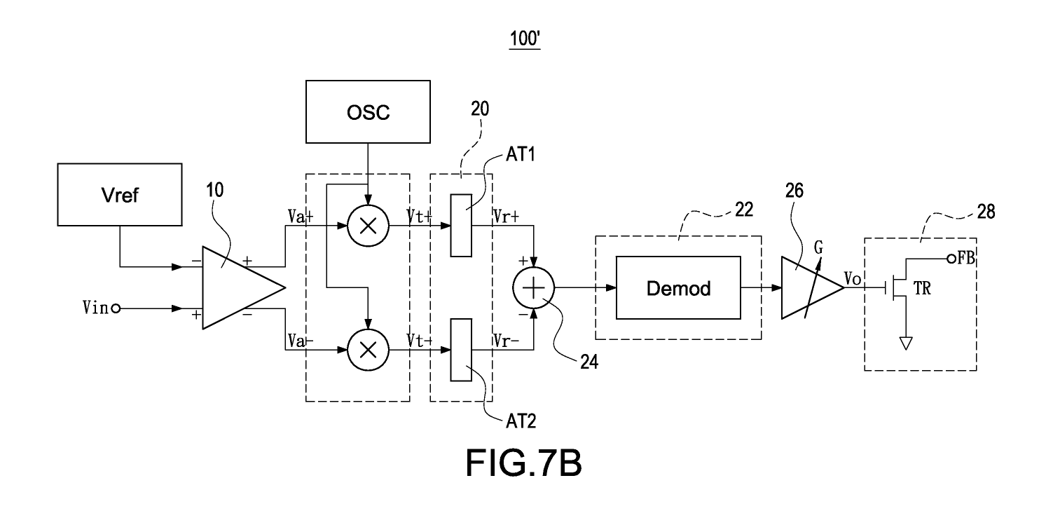

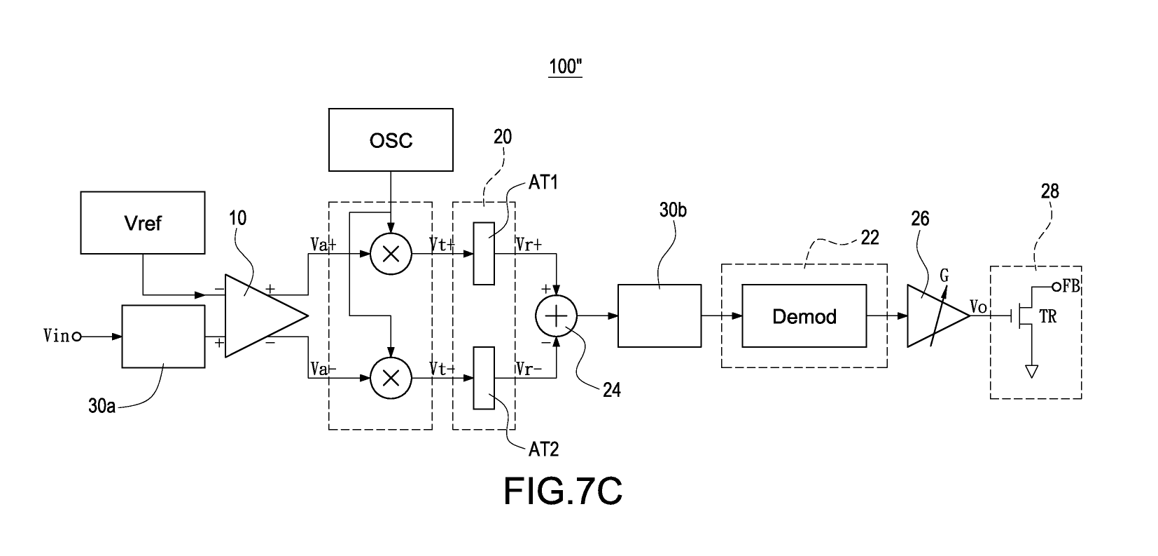

FIG. 7A shows the block diagram of the proposed isolated feedback system 100 according to a preferred embodiment of the present invention. The isolated feedback system 100 comprises an input amplifier 10, an AM modulator 12, an acoustic transformer unit 20, an AM demodulator 22, a subtractor 24, an output amplifier 26 with adjustable gain, and optionally an open drain driver 28. The input amplifier 10 is, for example, an error amplifier, or a full-differential error amplifier. When the input amplifier 10 is an error amplifier, it has two inputs to receive an input signal Vin and a reference voltage Vref, respectively and generates an error signal. When the input amplifier 10 is a full-differential amplifier, it has two differential inputs for receiving an input signal Vin and a reference voltage Vref, respectively, and generates two differential output signals.

To explain the operation of the isolated feedback system 100, AM modulation is chosen as the modulation method, as it is easy to implement. The same principle applies to other modulation methods such as FM modulation.

Taking the input amplifier 10 as a full-differential error amplifier for example, the input amplifier compares the input voltage Vin having bandwidth f0 with the reference voltage Vref.

The difference is converted into differential signals Va+ and Va− through the differential outputs of the input amplifier 10. If the input amplifier 10 has a gain of A, and assume the common mode voltage at the amplifier output to be Vcm, then

Va+=Vcm+A(Vin−Vref)

Va−=Vcm−A(Vin−Vref)

The AM modulator 12 modulates the differential signals Va+ and Va− with a carrier frequency fc to generate modulated signals Vt+ and Vt−. With reference again to FIG. 6B, the carrier frequency fc is determined by the characteristics of the acoustic transformer that the modulated signal can pass through the isolation barrier efficiently. Furthermore, the carrier frequency fc is chosen to be away from resonant frequencies such that the frequency response between (fc−f0) and (fc+f0) is substantially flat.

The modulated signals Vt+ and Vt− are sent to the acoustic transformer unit 20, which is a differential acoustic transformer unit composed of a first acoustic transformer AT1 and a second acoustic transformer AT2. It should be noted that when the input amplifier 10 is an error amplifier and generates one error signal, the acoustic transformer unit 20 can be realized by a single acoustic transformer with a signal input end and a signal output end. Moreover, in this situation, the AM modulator 12 and the AM demodulator 22 perform AM modulation/demodulation for the signal to be transmitted to the single acoustic transformer and the signal output from the single acoustic transformer, respectively.

The signals received on the other side of the acoustic transformer unit 20 are denoted as Vr+ and Vr−. Depending on the transformer, it is either an amplified or attenuated version of the modulated signals Vt+ and Vt−. The DC information will be lost during transmission and the common mode voltage of Vr+ and Vr− are determined by the receiver bias condition.

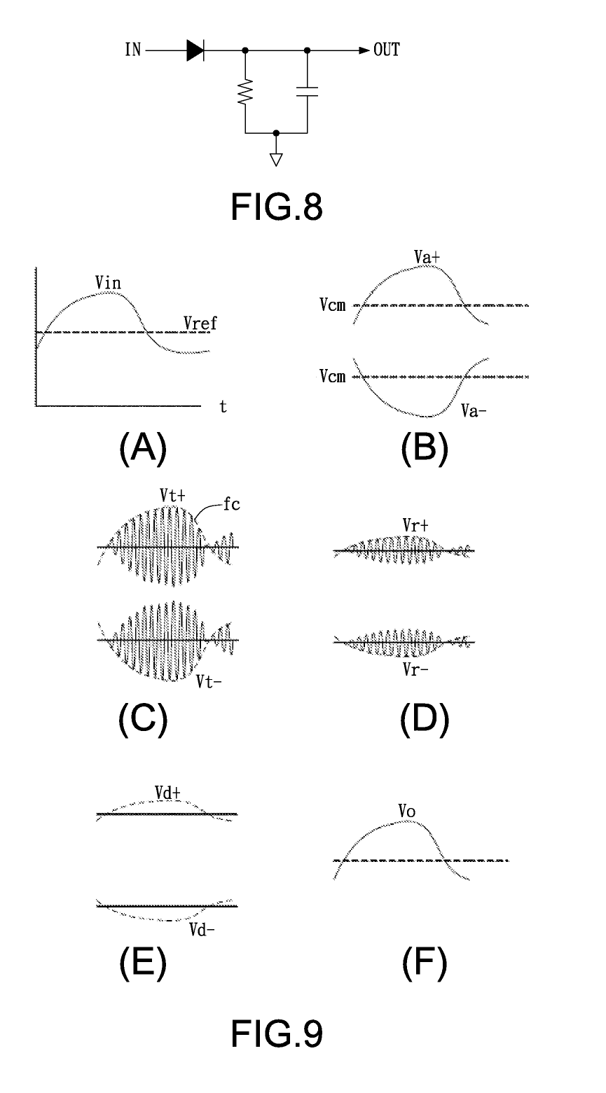

The signals Vr+ and Vr− will be demodulated by the AM demodulator 22 to recover the original signal (Vin-Vref) and −(Vin-Vref) with a scaling factor. For AM modulated signal, the simplest demodulation method is to detect the envelope/peak of the waveform. An example of the peak detection circuit is shown in FIG. 8.

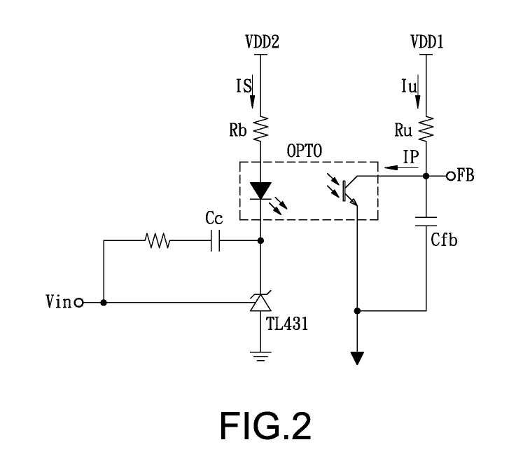

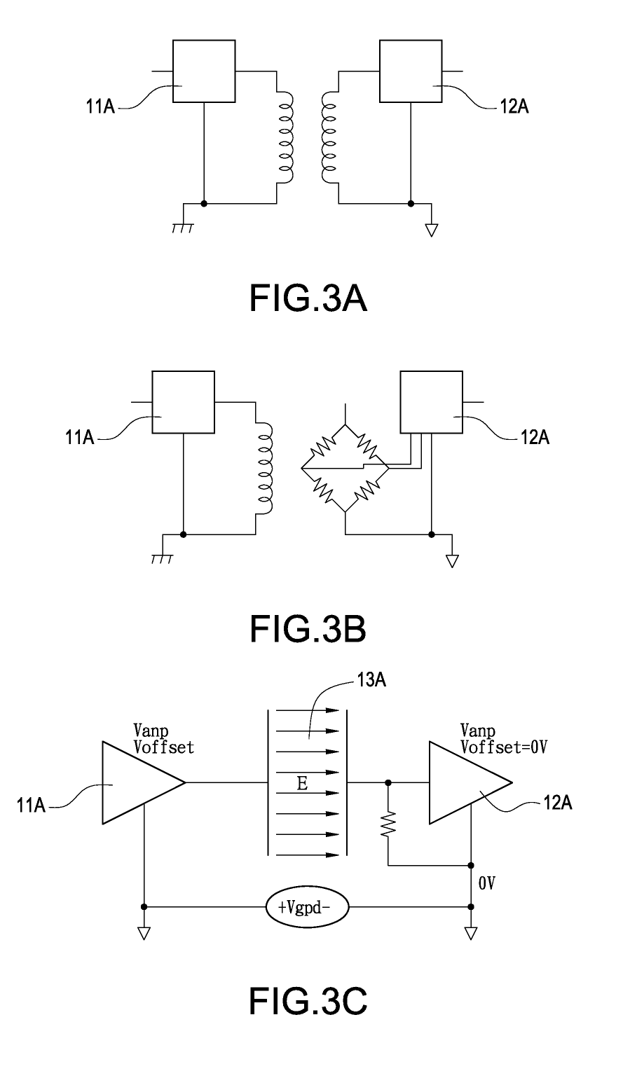

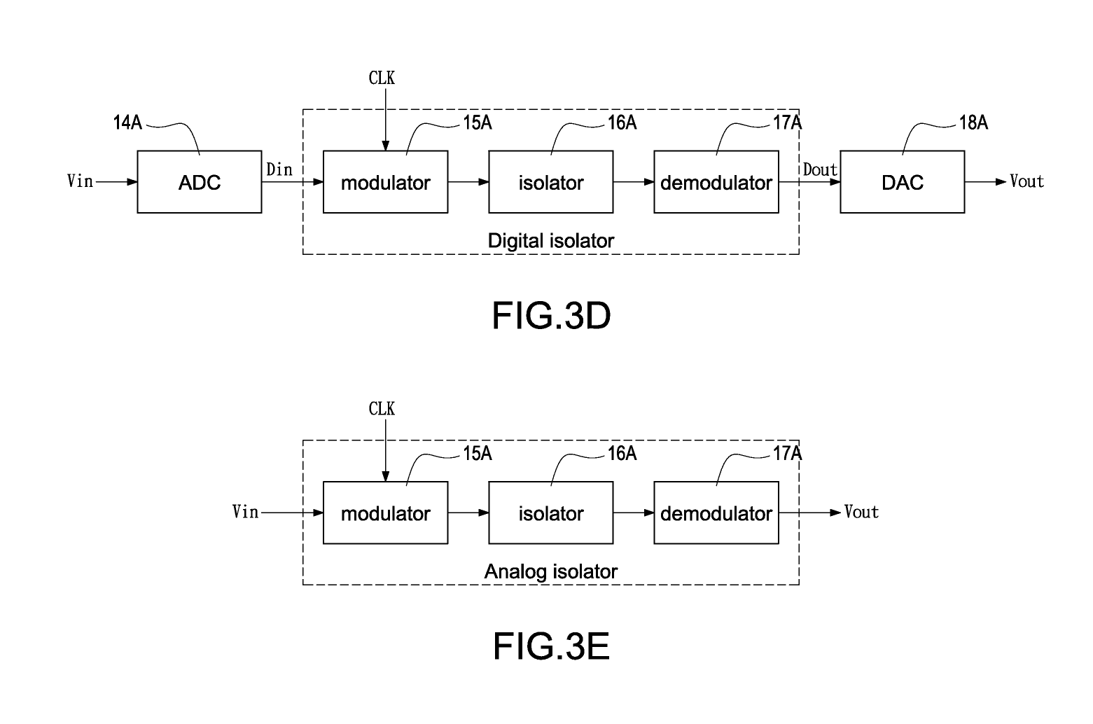

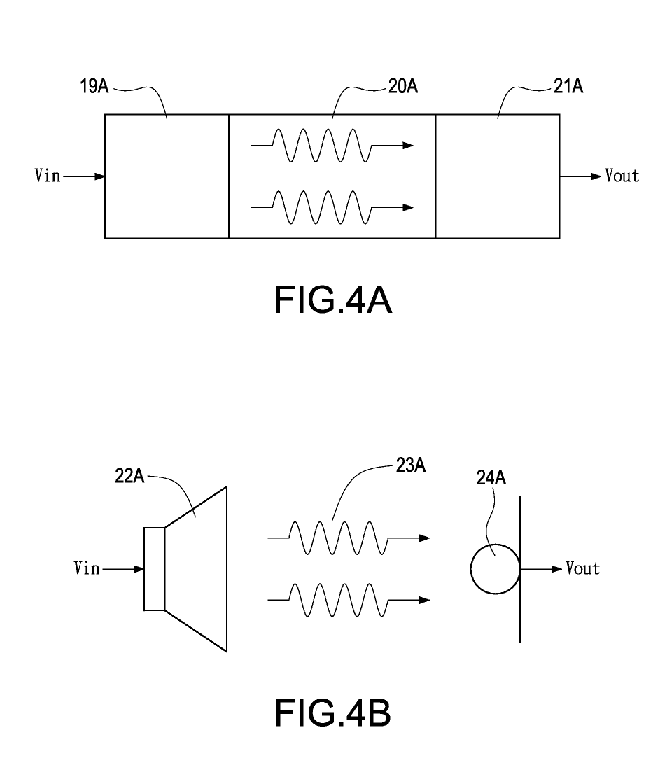

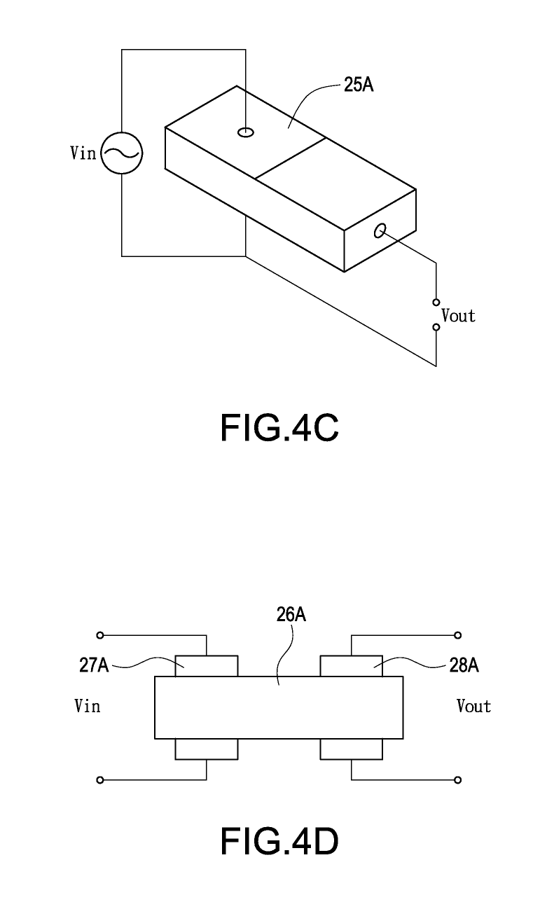

As shown in FIG. 7A, a subtractor 24 followed by the output amplifier 26 yields the output voltage Vo. In ideal conditions, the output voltage Vo will be proportional to (Vin-Vref). Notice that any common-mode voltage originally presented in Vr+ and Vr− are eliminated by the subtract operation. The concern of CMRR mentioned by S. Lineykin and S. Ben-Yaakov is resolved. To emulate the original open drain output of FIG. 2, an open drain driver 28 (which can be realized by a MOS or Bipolar transistor TR) will be used as the output stage and is connected to the output amplifier 26. Moreover, when the input amplifier 10 is an error amplifier and generates one error signal, the subtractor 24 shown in FIG. 7A can be eliminated.

The waveforms of different stages are shown in FIGS. 9A-9F for demonstrating the isolated feedback system 100 shown in FIG. 7A. More particularly, FIG. 9A shows the waveform of the input voltage Vin to be sent to one input of the input amplifier 10, and the relevant level of the reference voltage Vref. The input voltage Vin and the reference voltage Vref are differentially amplified by the input amplifier 10 to generate the differential signals Va+ and Va− at the differential output of the input amplifier 10 as shown in FIG. 9B. The differential signals Va+ and Va− are amplitude modulated by the AM modulator 12 with carrier frequency fc provided by an oscillator 12a to generate two modulated signals Vt+ and Vt−, as shown in FIG. 9C. The two modulated signals Vt+ and Vt− are sent and transmitted through the first acoustic transformer AT1 and a second acoustic transformer AT2 of the differential acoustic transformer 20, respectively. Because the modulated signals Vt+ and Vt− are modulated at a carrier frequency fc substantially away from the resonant frequencies of the differential acoustic transformer 20 and the frequency response between (fc−f0) and (fc+f0) is substantially flat, the modulated signals Vt+ and Vt− pass through the differential acoustic transformer 20 with less distortion and better immunity to noise and become received signals Vr+ and Vr− on the other side of the differential acoustic transformer 20, as shown in FIG. 9D. As shown in FIGS. 9C and 9D, the received signals Vr+ and Vr− are amplified or attenuated version of the modulated signals Vt+ and Vt− with different common mode voltage, which depends on the receiver bias condition. The received signals Vr+ and Vr− are demodulated by the AM demodulator 22 to obtain recovery signals Vd+ and Vd−, which recover the original signal (Vin-Vref) and −(Vin-Vref) with a scaling factor as shown in FIG. 9E. Finally, the recovery signals Vd+ and Vd− output by the AM demodulator 22 are processed by the subtractor 24 to yield the output voltage Vo as shown in FIG. 9F.

In FIG. 7A, a MOS or Bipolar transistor TR is added so the feedback system is compatible with common PWM controllers. As explained in FIG. 2, the conventional feedback system is one-sided in that TL431 behaves like a transconductance amplifier when input voltage is larger than the internal reference voltage of TL431. When the input voltage is smaller than the internal reference voltage, the TL431 current output will be zero and the optocoupler will not draw current on the feedback signal FB. In this condition, the system relies on the pull up resistor Ru to provide the feedback signal. The pull up resistor Ru needs to be small enough that the pull up action is much faster than the feedback signal bandwidth. Hence the operation of FIG. 2 is not linear. A typical value for the pull up resistor Ru is about 20 k with Cfb=1000 pF. With a 5V supply and nominal voltage FB at 1V, it consumes about 200 uA of current.

On the contrary, in FIG. 7A, the relationship between Vin and Vo has a linear relationship if the transformer is linear. A modified PWM controller can be designed to take advantage of this property that instead of using Ru to generate FB, Vo is used as the feedback signal directly. There is no need to consume a large pull up current hence the system power consumption can be reduced.

FIG. 7B shows the block diagram of the proposed isolated feedback system 100′ according to another preferred embodiment of the present invention. The isolated feedback system 100′ has similar elements to the isolated feedback system 100 shown in FIG. 7A, and the similar elements use similar numerals for brevity. The subtractor 24′ in the proposed isolated feedback system 100′ is connected between the differential acoustic transformer 20 and the AM demodulator 22′, therefore, only one AM demodulator 22′ is necessary. In other words, the received signals of the differential acoustic transformer 20 are subtracted by the subtractor 24′ before being demodulated by the AM demodulator 22′.

FIG. 7C shows the block diagram of the proposed isolated feedback system 100″ according to still another preferred embodiment of the present invention. The isolated feedback system 100″ has similar elements as the isolated feedback system 100′ shown in FIG. 7B, and similar elements use similar numerals for brevity. In comparison with the example shown in FIG. 7B, the isolated feedback system 100″ further comprises an input low pass filter 30a connected between the input voltage Vin and the positive input end of the input amplifier 10. Moreover, a band pass filter 30b is electrically connected between the subtractor 24″ and the AM demodulator 22″ to remove noise from the output of the subtractor 24″. The frequency response curve of the band pass filter 30b is, for example, indicated by the dashed curve of receiving filter shown in FIG. 6B.

An efficient feedback system using acoustic transformer is proposed. It has the following properties:

1. It directly modulates the input signals and transmits them through the isolation layers. No ADCs and DACs are required.

2. The input and output interface are identical to the optocoupler based feedback system as shown in FIG. 2.

3. The carrier frequency is chosen at the flat region of the frequency response of the differential gain. It is away from the resonant frequencies.

4. A fully differential structure is adopted to reject common mode signals and noise.

5. Optional filters are added to further reject unwanted noises.

6. The current consumption is less than the optocoupler based feedback system because the energy required for transmitting the signals through acoustic based transformers is smaller than the energy required by the optocoupler.

What is claimed is:

1. An isolated feedback system for power converters comprising:
an error amplifier for receiving an input voltage and outputting an error signal;
a modulator circuit to modulate the error signal with a carrier signal;
an acoustic transformer unit, one end of the acoustic transformer unit being connected to the modulator circuit, where a frequency of the carrier signal is away from resonant frequencies of the acoustic transformer unit; and
a demodulation circuit connected to the other end of the acoustic transformer unit and receiving the modulated signal.

2. The isolated feedback system of claim 1, wherein the error amplifier is a fully-differential error amplifier and outputs two differential signals, and the two differential signals are modulated by the modulator circuit to form two modulated signals.

3. The isolated feedback system of claim 2, wherein the acoustic transformer unit comprises a first acoustic transformer and a second acoustic transformer for receiving the two modulated signals.

4. The isolated feedback system of claim 3, further comprising a subtractor connected to the output of the demodulation circuit, wherein the subtractor subtracts two demodulated signals output from the demodulation circuit.

5. The isolated feedback system of claim 3, further comprising a subtractor connected between the acoustic transformer unit and the demodulation circuit to subtract the output signals of the first acoustic transformer and the second acoustic transformer.

6. The isolated feedback system of claim 5, further comprising an input low pass filter connected to one input end of the fully-differential error amplifier.

7. The isolated feedback system of claim 5, further comprising a band pass filter connected to the input of the demodulation circuit.

8. The isolated feedback system of claim 1, wherein the modulation circuit is an AM or FM modulation circuit.

9. The isolated feedback system of claim 8, wherein the demodulation circuit is an AM or FM demodulation circuit.

10. The isolated feedback system of claim 1, wherein the acoustic transformer unit is a piezoelectric acoustic transformer.

11. A method for providing isolated feedback for power converters comprising:
(a) receiving an input voltage and a reference voltage to output at least one error signal;
(b) modulating the error signal with a carrier signal to generate at least one modulated signal;
(c) sending the modulated signal through an acoustic transformer unit, where a frequency of the carrier signal is away from resonant frequencies of the acoustic transformer unit; and
(d) demodulating at least one output signal of the acoustic transformer unit.

12. The method of claim 11, wherein the step (a) is performed by a fully-differential error amplifier to output two differential signals.

13. The method of claim 12, wherein the two differential signals are modulated by two modulators in step (b).

14. The method of claim 13, wherein two modulated signals output from the two modulators are sent through two acoustic transformers, respectively in step (c).

15. The method of claim 14, wherein two output signals from the two acoustic transformers are demodulated by two demodulators in step (d).

16. The method of claim 15, further comprising:
(e) subtracting the two demodulated signals.

17. The method of claim 14, further comprising:
(c1) subtracting two output signals from the two acoustic transformers.

18. The method of claim 16, further comprising:
low pass filtering the input voltage before the step (a).

19. The method of claim 18, further comprising:
after the step (c1), band pass filtering the subtracted signal.
